(19) United States
(12) Patent Application Publication
(10) Pub. No.: US 2025/0210710 A1
(43) Pub. Date: Jun. 26, 2025

(54) ELECTROLYTE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Erang CHO, Yongin-si (KR); JIN-HYEOK LIM, Yongin-si (KR); JINAH SEO, Yongin-si (KR); SANGHOON KIM, Yongin-si (KR); Sujeong KOH, Yongin-si (KR); Bomee KWON, Yongin-si (KR); Euisoo JEONG, Yongin-si (KR); SUNDAE KIM, Yongin-si (KR)

(21) Appl. No.: 18/785,478

(22) Filed: Jul. 26, 2024

(30) Foreign Application Priority Data
Dec. 22, 2023 (KR) 10-2023-0189555

(51) Int. Cl. H01M 10/0567; H01M 4/02; H01M 4/525; H01M 10/052; H01M 10/0569

(52) U.S. Cl. CPC H01M 10/0567; H01M 4/525; H01M 10/052; H01M 10/0569; H01M 2004/027; H01M 2004/028

(57) ABSTRACT

Electrolytes and rechargeable lithium batteries including the same are disclosed. The electrolyte includes a non-aqueous organic solvent, a lithium salt, and an additive. The additive includes Compound 1 represented by Chemical Formula 1 and Compound 2 represented by Chemical Formula 2.

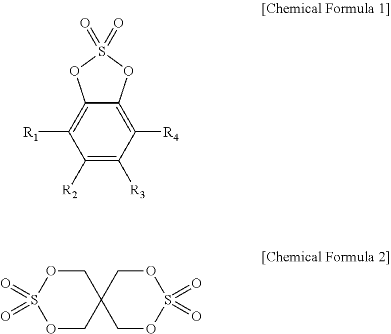

### CROSS-REFERENCE TO RELATED APPLICATION

The present application claims priority to and the benefit of Korean Patent Application No. 10-2023-0189555, filed on Dec. 22, 2023, in the Korean Intellectual Property Office, the entire content of which is incorporated herein by reference.

### BACKGROUND

### (a) Field

The present disclosure relates to an electrolyte for a rechargeable lithium battery and a rechargeable lithium battery including the same.

### (b) Description of the Related Art

Recently, with the rapid spread of battery-utilizing (e.g., battery-operated) electronic devices, such as mobile phones, laptop computers, and/or electric vehicles, there is a rapidly increasing demand or desire for rechargeable batteries with relatively high energy density and relatively high capacity. Therefore, intensive research has been conducted to improve performance of rechargeable lithium batteries.

A rechargeable lithium battery includes a positive electrode, a negative electrode, and an electrolyte, of which, the positive and negative electrodes each include an active material capable of intercalation and deintercalation of lithium ions, and generates electrical energy through oxidation and reduction reactions if (e.g., when) lithium ions are intercalated and deintercalated.

A lithium salt dissolved in a non-aqueous organic solvent is utilized as the electrolyte of the rechargeable lithium battery. Characteristics of the rechargeable lithium battery are exhibited by complex reactions between the positive electrode and the electrolyte and between the negative electrode and the electrolyte. Accordingly, the usage of an appropriate or suitable electrolyte is one of the importance variables for improvement of the rechargeable lithium battery.

### SUMMARY

Aspects according to some embodiments are directed toward an electrolyte for a rechargeable lithium battery with improved stability and lifetime characteristics at relatively high temperatures.

Aspects according to some embodiments are directed toward a rechargeable lithium battery including the electrolyte.

Additional aspects will be set forth in part in the description which follows and, in part, will be apparent from the description, or may be learned by practice of the presented embodiments of the disclosure.

According to one or more embodiments of the present disclosure, an electrolyte for a rechargeable lithium battery may include: a non-aqueous organic solvent; a lithium salt; and an additive. The additive may include Compound 1 represented by Chemical Formula 1 and Compound 2 represented by Chemical Formula 2.

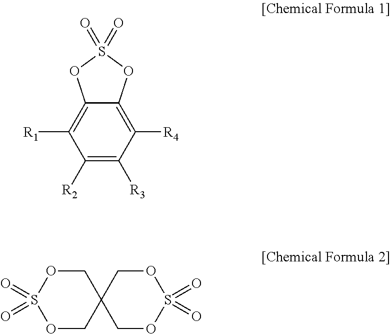

In Chemical Formula 1, R₁ to R₄ may each independently be a hydrogen atom (i.e., may be hydrogen or H), a halogen atom, or a substituted or unsubstituted C₁ to C₅ alkyl group.

According to one or more embodiments of the present disclosure, a rechargeable lithium battery may include: a positive electrode that includes a positive electrode active material; a negative electrode that includes a negative electrode active material; and the electrolyte discussed above.

### BRIEF DESCRIPTION OF DRAWINGS

The accompanying drawing is included to provide a further understanding of the present disclosure and is incorporated in and constitute a part of this specification. The drawing illustrates embodiments of the present disclosure and, together with the description, serves to explain principles of the present disclosure. In the drawings,

FIG. 1 is a diagram schematically showing a rechargeable lithium battery according to one or more embodiments of the present disclosure.

FIG. 2 is a schematic illustration of a cylindrical battery according to some embodiments.

FIG. 3 is a schematic illustration of a prismatic battery according to some embodiments.

FIG. 4 is a schematic illustration of a pouch-type or kind battery according to some embodiments.

FIG. 5 is a schematic illustration of a pouch-type or kind battery according to some embodiments.

### DETAILED DESCRIPTION

In order to sufficiently understand the configuration and effect of the present disclosure, one or more embodiments of the present disclosure will be described with reference to the accompanying drawings. It should be noted, however, that the present disclosure is not limited to the following example embodiments, and may be implemented in one or more suitable forms. Rather, the example embodiments are provided only to let those skilled in the art fully understand the scope of the present disclosure.

In this description, it will be understood that, if (e.g., when) an element is referred to as being on another element, the element can be directly on the other element or intervening elements may be present therebetween. In the drawings, thicknesses of some components are exaggerated for effectively explaining the technical contents. Like reference numerals refer to like elements throughout, and duplicative descriptions thereof may not be provided in the specification.

Unless otherwise specially noted in this description, the expression of singular form may include the expression of plural form. In addition, unless otherwise specially noted, the phrase “A or B” may indicate “A but not B”, “B but not A”, and “A and B”. The terms “comprises/includes” and/or “comprising/including” used in this description do not exclude the presence or addition of one or more other components.

In this description, the term “combination thereof” may refer to a mixture, a stack, a composite, a copolymer, an alloy, a blend, or a reaction product of the constituents.

In this description, unless otherwise separately defined, the term “substituted” may refer to that at least one hydrogen of a substituent or a compound is substituted by deuterium, a halogen group, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, and/or a (e.g., any suitable) combination thereof.

For example, the term “substituted” may refer to that at least one hydrogen of a substituent or a compound is substituted by deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, the term “substituted” may refer to that at least one hydrogen of a substituent or a compound is substituted by deuterium, a halogen group, a C1 to C20 alkyl group, a C6 to C30 aryl group, a C1 to C10 fluoroalkyl group, or a cyano group. In one or more embodiments, the term “substituted” may refer to that at least one hydrogen of a substituent or a compound is substituted by deuterium, a halogen group, a C1 to C5 alkyl group, a C6 to C18 aryl group, a C1 to C5 fluoroalkyl group, or a cyano group. For example, the term “substituted” may refer to that at least one hydrogen of a substituent or a compound is substituted by deuterium, a cyano group, a halogen group, a methyl group, an ethyl group, a propyl group, a butyl group, a phenyl group, a biphenyl group, a terphenyl group, a trifluoromethyl group, or a naphthyl group.

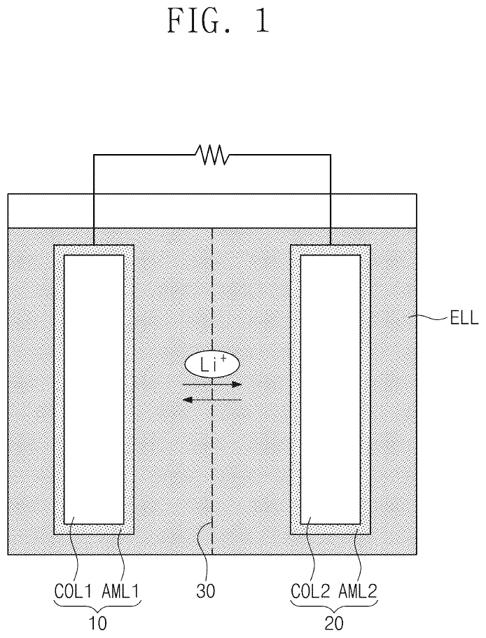

FIG. 1 illustrates a simplified conceptual diagram showing a rechargeable lithium battery according to one or more embodiments of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced and/or apart (e.g., spaced apart or separated) from each other across the separator 30. The separator 30 may be arranged between the positive electrode 10 and the negative electrode 20. The positive electrode 10, the negative electrode 20, and the separator 30 may be in contact with the electrolyte ELL. For example, the positive electrode 10, the negative electrode 20, and the separator 30 may be impregnated in the electrolyte ELL.

The electrolyte ELL may be a medium by which lithium ions are transferred between the positive electrode 10 and the negative electrode 20. In the electrolyte ELL, the lithium ions may move through the separator 30 toward one of the positive electrode 10 and the negative electrode 20.

### Positive Electrode 10

The positive electrode 10 for a rechargeable lithium battery may include a current collector COL1 and a positive electrode active material layer AML1 formed on the current collector COL1. The positive electrode active material layer AML1 may include a positive electrode active material and may further include a binder and/or a conductive material.

In some embodiments, the positive electrode 10 may further include an additive that can serve as a sacrificial positive electrode.

An amount of the positive electrode active material may range from about 90 wt % to about 99.5 wt % based on 100 wt % of the positive electrode active material layer AML1. Amounts of the binder and the conductive material may each be about 0.5 wt % to about 5 wt % based on 100 wt % of the positive electrode active material layer AML1.

The binder may serve to improve attachment of positive electrode active material particles to each other and also to improve attachment of the positive electrode active material to the current collector COL1. The binder may include, for example, polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, or nylon, but the present disclosure is not limited thereto.

The conductive material (e.g., electron conductor) may be utilized to provide an electrode with conductivity, and any suitable conductive material without causing chemical change of a battery may be utilized as the conductive material to constitute the battery. The conductive material may include, for example, a carbon-based material such as natural graphite, artificial graphite, carbon black, acetylene black, Ketjen black, carbon fiber, carbon nano-fiber, and/or carbon nano-tube; a metal powder or metal fiber containing one or more of copper (Cu), nickel (Ni), aluminum (Al), and silver (Ag); a conductive polymer such as a polyphenylene derivative; and/or a (e.g., any suitable) mixture thereof.

In some embodiments, Al may be utilized as the current collector COL1, but the present disclosure is not limited thereto.

### Positive Electrode Active Material

The positive electrode active material in the positive electrode active material layer AML1 may include a compound (e.g., lithiated intercalation compound) that can reversibly intercalate and de-intercalate lithium. For example, the positive electrode active material may include at least one kind of composite oxide including lithium and a metal that is selected from among cobalt (Co), manganese (Mn), nickel (Ni), and/or a (e.g., any suitable) combination thereof.

The composite oxide may include lithium transition metal composite oxide, for example, lithium-nickel-based oxide, lithium-cobalt-based oxide, lithium-manganese-based oxide, lithium-iron (Fe)-phosphate (P)-based compounds, cobalt-free nickel-manganese-based oxide, and/or a (e.g., any suitable) combination thereof.

For example, the positive electrode active material may include a compound represented by one of (e.g., one selected from among) the chemical formulae below. LiₐA_{1-b}X_{b}O_{2-c}D_{c} (0.90≤a≤1.8, 0≤b≤0.5, 0≤c≤0.05), LiₐMn_{2-b}X_{b}O_{4-c}D_{c} (0.90≤a≤1.8, 0≤b≤0.5, 0≤c≤0.05), LiₐNi_{1-b-c}CO_{b}X_{c}O_{2-α}Dₐ (0.90≤a≤1.8, 0≤b≤0.5, 0≤c≤0.5, 0<α<2), LiₐNi_{1-b-c}Mn_{b}X_{c}O_{2-α}D_{α} (0.90≤a≤1.8, 0≤b≤0.5, 0≤c≤0.5, 0<α<2), LiₐNi_{b}Co_{c}L¹_{d}GₑO₂ (0.90≤a≤1.8, 0≤b≤0.9, 0≤c≤0.5, 0≤d≤0.5, 0≤e≤0.1), LiₐNiG_{b}O₂ (0.90≤a≤1.8, 0.001≤b≤0.1), LiₐCoG_{b}O₂ (0.90≤a≤1.8, 0.001≤b≤0.1), LiₐMn_{1-b}GbO₂ (0.90≤a≤1.8, 0.001≤b≤0.1), LiₐMn₂GbO₄ (0.90≤a≤1.8, 0.001≤b≤0.1), LiₐMn_{1-g}G_{g}PO₄ (0.90≤a≤1.8, 0≤g≤0.5), Li_{(3-f)}Fe₂(PO₄)₃ (0≤f≤2), and/or LiₐFePO₄ (0.90≤a≤1.8).

In the chemical formulae above, A is Ni, Co, Mn, and/or a (e.g., any suitable) combination thereof, X is Al, Ni, Co, Mn, Cr, Fe, Mg, Sr, V, a rare element, and/or a (e.g., any suitable) combination thereof, D is O, F, S, P, and/or a (e.g., any suitable) combination thereof, G is Al, Cr, Mn, Fe, Mg, La, Ce, Sr, V, and/or a (e.g., any suitable) combination thereof, and L¹ is Mn, Al, and/or a (e.g., any suitable) combination thereof.

For example, the positive electrode active material may be a high nickel-based positive electrode active material having a nickel content (e.g., amount) of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % based on 100 mol % of all metals devoid of (excluding, not counting) lithium in the lithium transition metal composite oxide. The high nickel-based positive electrode active material may achieve high capacity and thus may be applied to a high-capacity and high-density rechargeable lithium battery.

### Negative Electrode 20

The negative electrode 20 for a rechargeable lithium battery may include a current collector COL2 and a negative electrode active material layer AML2 positioned on the current collector COL2. The negative electrode active material layer AML2 may include a negative electrode active material and may further include a binder and/or a conductive material.

For example, (based on 100 wt % of the negative electrode active material layer AML2), the negative electrode active material layer AML2 may include a negative electrode active material at about 90 wt % to about 99 wt %, a binder at about 0.5 wt % to about 5 wt %, and a conductive material at about 0 wt % to about 5 wt %.

The binder may serve to improve attachment of negative electrode active material particles to each other and also to improve attachment of the negative electrode active material to the current collector COL2. The binder may include a non-aqueous binder, an aqueous binder, a dry binder, and/or a (e.g., any suitable) combination thereof.

The non-aqueous binder may include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, and/or a (e.g., any suitable) combination thereof.

The aqueous binder may include a styrene-butadiene rubber, a (meth)acrylated styrene-butadiene rubber, a (meth)acrylic rubber, a butyl rubber, a fluoro elastomer, polyethylene oxide, polyvinyl pyrrolidone, polyepichlorohydrin, polyphosphazene, poly(meth)acrylonitrile, an ethylene propylene diene copolymer, polyvinyl pyridine, chlorosulfonated polyethylene, latex, a polyester resin, a (meth)acrylic resin, a phenolic resin, an epoxy resin, polyvinyl alcohol, and/or a (e.g., any suitable) combination thereof.

If (e.g., when) an aqueous binder is utilized as the negative electrode binder, a cellulose-based compound capable of providing a suitable viscosity may further be included. The cellulose-based compound may include one or more of carboxymethyl cellulose, hydroxypropylmethyl cellulose, methyl cellulose, and alkali metal salts thereof. The alkaline metal may include Na, K, or Li.

The dry binder may include a fibrillizable (e.g., capable of being shaped in the form of a fiber) polymer material, for example, polytetrafluoroethylene, polyvinylidene fluoride, polyvinylidene fluoride-hexafluoropropylene copolymer, polyethylene oxide, and/or a (e.g., any suitable) combination thereof.

The conductive material (e.g., electron conductor) may be utilized to provide an electrode with conductivity, and any suitable conductive material without causing chemical change of a battery may be utilized as the conductive material to constitute the battery. For example, the conductive material may include a carbon-based material such as natural graphite, artificial graphite, carbon black, acetylene black, Ketjen black, carbon fiber, carbon nano-fiber, and/or carbon nano-tube; a metal powder or metal fiber including one or more of copper, nickel, aluminum, and silver; a conductive polymer such as a polyphenylene derivative; and/or a (e.g., any suitable) mixture thereof.

The current collector COL2 may include a copper foil, a nickel foil, a stainless-steel foil, a titanium (Ti) foil, a nickel foam, a copper foam, a polymer substrate coated with a conductive metal, and/or a (e.g., any suitable) combination thereof.

### Negative Electrode Active Material

The negative electrode active material may include a material that can reversibly intercalate and de-intercalate lithium ions, lithium metal, a lithium metal alloy, a material that can dope and de-dope lithium ions, and/or a transition metal oxide.

The material that can reversibly intercalate and de-intercalate lithium ions may include a carbon-based negative electrode active material, for example, crystalline carbon, amorphous carbon, and/or a (e.g., any suitable) combination thereof. For example, the crystalline carbon may include graphite such as non (e.g., irregularly)-shaped, sheet-shaped, flake-shaped, sphere-shaped, or fiber-shaped natural or artificial graphite, and the amorphous carbon may include soft carbon, hard carbon, mesophase pitch carbon, or calcined coke.

The lithium metal alloy may include an alloy of lithium and a metal that is selected from among Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material or a Sn-based negative electrode active material. The Si-based negative electrode active material may include silicon, silicon-carbon composite, SiOx (0<x≤ 2), Si-Q alloy (where Q is an alkali metal, an alkaline earth metal, a Group 13 element, a Group 14 element (except for or excluding Si), a Group 15 element, a Group 16 element, a transition metal, a rare-earth element, and/or a (e.g., any suitable) combination thereof), and/or a (e.g., any suitable) combination thereof. The Sn-based negative electrode active material may include Sn, SnOₓ (0<x≤2, e.g., SnO₂), a Sn-based alloy, or a combination thereof.

The silicon-carbon composite may be a composite of silicon and amorphous carbon. According to one or more embodiments, the silicon-carbon composite may have a structure in which the amorphous carbon is coated on a surface of the silicon particle. For example, the silicon-carbon composite may include a secondary particle (core) in which primary silicon particles are assembled (e.g., aggregated), and an amorphous carbon coating layer (shell) positioned on a surface of the secondary particle. The amorphous carbon may also be positioned between the primary silicon particles, and for example, the primary silicon particles may be coated with the amorphous carbon. The secondary particles may be dispersed in an amorphous carbon matrix.

The silicon-carbon composite may further include crystalline carbon. For example, the silicon-carbon composite may include a core including crystalline carbon and silicon particles and may also include an amorphous carbon coating layer positioned on a surface of the core.

In some embodiments, the Si-based negative electrode active material or the Sn-based negative electrode active material may be utilized in combination with a carbon-based negative electrode active material.

### Separator 30

Based on type or kind of the rechargeable lithium battery, the separator 30 may be present between the positive electrode 10 and the negative electrode 20. The separator 30 may include one or more of polyethylene, polypropylene, and polyvinylidene fluoride, and may have a multi-layered structure such as a polyethylene/polypropylene bi-layered separator, a polyethylene/polypropylene/polyethylene tri-layered separator, and/or a polypropylene/polyethylene/polypropylene tri-layered separator.

The separator 30 may include a porous substrate and a coating layer positioned on one surface or two opposite surfaces of the porous substrate, and the coating layer may include an organic material, an inorganic material, and/or a (e.g., any suitable) combination thereof.

The porous substrate may be a polymer layer including one selected from among polyolefin such as polyethylene and/or polypropylene, polyester such as polyethylene terephthalate and/or polybutylene terephthalate, polyacetal, polyamide, polyimide, polycarbonate, polyetherketone, polyaryletherketone, polyetherimide, polyamideimide, polybenzimidazole, polyethersulfone, polyphenylene oxide, cyclic olefin copolymer, polyphenylene sulfide, polyethylene naphthalate, glass fiber, and polytetrafluoroethylene (e.g., TEFLON), or may be a copolymer or mixture including two or more of the materials mentioned above.

The organic material may include a polyvinylidene fluoride-based copolymer or a (meth)acrylic copolymer.

The inorganic material may include an inorganic particle selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, and/or a (e.g., any suitable) combination thereof, but the present disclosure is not limited thereto.

The organic material and the inorganic material may be mixed in one coating layer or may be present in a stacked structure of a coating layer including (e.g., only) the organic material and a coating layer including (e.g., only) an inorganic material.

### Electrolyte ELL

The electrolyte ELL for a rechargeable lithium battery may include a non-aqueous organic solvent and a lithium salt.

The non-aqueous organic solvent may serve as a medium for transmitting (e.g., transporting) ions that participate in an electrochemical reaction of a battery.

The non-aqueous organic solvent may include a carbonate-based solvent, an ester-based solvent, an ether-based solvent, a ketone-based solvent, an alcohol-based solvent, an aprotic solvent, and/or a (e.g., any suitable) combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), and/or butylene carbonate (BC).

The ester-based solvent may include methyl acetate, ethyl acetate, n-propyl acetate, dimethyl acetate, methyl propionate, ethyl propionate, decanolide, mevalonolactone, valerolactone, and/or caprolactone.

The ether-based solvent may include dibutyl ether, tetraglyme, diglyme, dimethoxyethane, 2-methyltetrahydrofuran, 2.5-dimethyltetrahydrofuran, and/or tetrahydrofuran. The ketone-based solvent may include cyclohexanone. The aprotic solvent may include one or more nitriles such as R-CN (where R is a hydrocarbon group having a C2 to C20 linear, branched, or cyclic structure and may include a double bond, an aromatic ring, or an ether group); amides such as dimethylformamide; dioxolanes such as 1,3-dioxolane and/or 1.4-dioxolane; and/or sulfolanes.

The non-aqueous organic solvent may be utilized alone or in a mixture of two or more substances (e.g., solvents).

In one or more embodiments, if (e.g., when) a carbonate-based solvent is utilized, a cyclic carbonate and a chain carbonate may be mixed and utilized, and the cyclic carbonate and the chain carbonate may be mixed in a volume ratio of about 1:1 to about 1:9.

The lithium salt may be a material that is dissolved in the non-aqueous organic solvent to serve as a supply source of lithium ions in a battery and plays a role in enabling a basic operation of a rechargeable lithium battery and in promoting the movement of lithium ions between the positive and negative electrodes. The lithium salt may include, for example, at least one selected from among LiPF₆, LiBF₄, LiSbF₆, LiAsF₆, LiClO₄, LiAlO₂, LiAlCl₄, LiPO₂F₂, LiCl, Lil, LiN(SO₃C₂F₅)₂, Li(FSO₂)₂N, lithium bis(fluorosulfonyl)imide (LIFSI), LiC₄F₉SO₃, LiN(CₓF₂ₓ₊₁SO₂)(C_{y}F_{2y+1}SO₂) (where x and y are each independently integers between 1 to 20), lithium trifluoromethane sulfonate, lithium tetrafluoroethanesulfonate, lithium difluorobis(oxalato)phosphate (LiDFOB), and lithium bis(oxalato) borate (LiBOB)

In some embodiments, the lithium salt may include LiPF₆.

The lithium salt may have a concentration of about 0.1 M to about 2.0 M.

In some embodiments, the additive may include a vinylene carbonate-based compound. The vinylene carbonate-based compound may be added to an electrolyte to form a solid electrolyte interface (SEI) layer. The vinylene carbonate-based compound may be vinylene carbonate, vinylene ethylene carbonate, and/or a (e.g., any suitable) combination thereof.

The vinylene carbonate-based compound may be about 0.01 wt % to about 5 wt % relative to (e.g., based on) the total weight of the electrolyte. For example, the vinylene carbonate-based compound may have an amount of equal to or greater than about 0.05 wt %, about 0.1 wt %, or about 0.5 wt % relative to the total weight of the electrolyte. The vinylene carbonate-based compound may have an amount of equal to or less than about 3 wt %, about 2 wt %, or about 1.5 wt % relative to the total weight of the electrolyte. When the vinylene carbonate-based compound has the aforementioned concentration (e.g., amount) in the electrolyte, an SEI layer having an appropriate or suitable resistance may be formed on an electrode surface of a lithium battery to improve cycle characteristics of the lithium battery.

The additive may include Compound 1 represented by Chemical Formula 1.

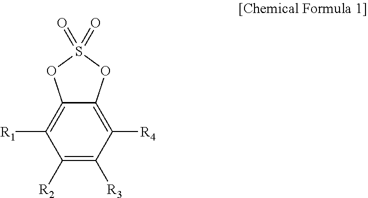

In Chemical Formula 1, R₁ to R₄ may independently be a hydrogen atom, a halogen atom, or a substituted or unsubstituted C1 to C5 alkyl group. In some embodiments, in Chemical Formula 1, R₁ to R₄ may each be a hydrogen element.

Compound 1 may have an amount of about 0.01 wt % to about 5 wt % relative to (e.g., based on) the total weight of the electrolyte. For example, Compound 1 may have an amount of equal to or greater than 0.05 wt %, or equal to or greater than 0.1 wt % relative to the total amount of the electrolyte. Compound 1 may have an amount of equal to or less than about 3 wt %, equal to or less than about 1.5 wt %, or equal to or less than about 1 wt % relative to the total weight of the electrolyte. When Compound 1 has the aforementioned concentration (e.g., amount), a protective film having an appropriate or suitable film resistance may be formed on an electrode surface of a lithium battery to improve cycle characteristics of the lithium battery, and gas generation in the lithium battery may be suppressed or reduced to improve high-temperature lifetime and high-temperature storage performance of a lithium battery.

The additive may include Compound 2 represented by Chemical Formula 2.

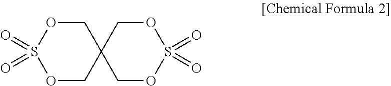 [SMILES: O=S1(=O)OCC2(CO1)COS(=O)(=O)OC2]

The additive including a compound represented by Chemical Formula 2 may be added to an electrolyte for a rechargeable lithium battery, and thus it may be possible to improve battery performance such as lifetime characteristics of the rechargeable lithium battery and to reduce gas generation and resistance change rate at high temperatures.

The compound represented by Chemical Formula 2 may include a structure in which two sulfate rings are linked to each other in a spiro form.

Compound 2 may have an amount of about 0.01 wt % to about 5 wt % relative to (e.g., based on) the total weight of the electrolyte. For example, Compound 2 may have an amount of equal to or greater than about 0.05 wt %, equal to or greater than about 0.1 wt %, or equal to or greater than about 0.5 wt % relative to the total weight of the electrolyte. Compound 2 may have an amount of equal to or less than about 3 wt %, equal to or less than about 2 wt %, or equal to or less than about 1.5 wt % relative to the total weight of the electrolyte. When Compound 2 has the aforementioned concentration, resistance of an electrode surface of a rechargeable lithium battery may be decreased (e.g., moderately decreased) to improve battery output performance.

The additive may include Compound 1 and Compound 2. Based on the combination of Compound 1 and Compound 2, the additive may improve not only high-temperature performance but also resistance increase rate of the rechargeable lithium battery, thereby improving battery output performance.

In the additive, Compound 2 may have an amount of about 1 to about 20 parts by weight relative to about 1 part by weight of Compound 1. For example, in the additive, Compound 2 may have an amount of about 1.5 to about 15 parts by weight or about 2 to about 10 parts by weight relative to about 1 part by weight of Compound 1. When Compound 1 and Compound 2 have the aforementioned ratio, a rechargeable lithium battery may improve in high-temperature performance and resistance increase rate, which may result in an improvement in battery output performance.

The additive may have an amount of about 0.1 wt % to about 10 wt % relative to (e.g., based on) the total weight of the electrolyte. For example, the additive may have an amount of about 0.5 wt % to about 7 wt %, about 1 wt % to about 4 wt %, about 2.1 wt % to about 4 wt %, or about 2.5 wt % to about 3.5 wt % relative to the total weight of the electrolyte. If (e.g., when) the additive is included in excess of the above ranges (e.g., more than about 7 wt %), viscosity of the electrolyte including the additive may be excessively (or substantially) increased to reduce the wettability to the positive and negative electrodes. In contrast, if (e.g., when) the additive is included in an amount less than the above ranges (e.g., less than about 0.5 wt), the effect mentioned above may be insignificant.

### Rechargeable Lithium Battery

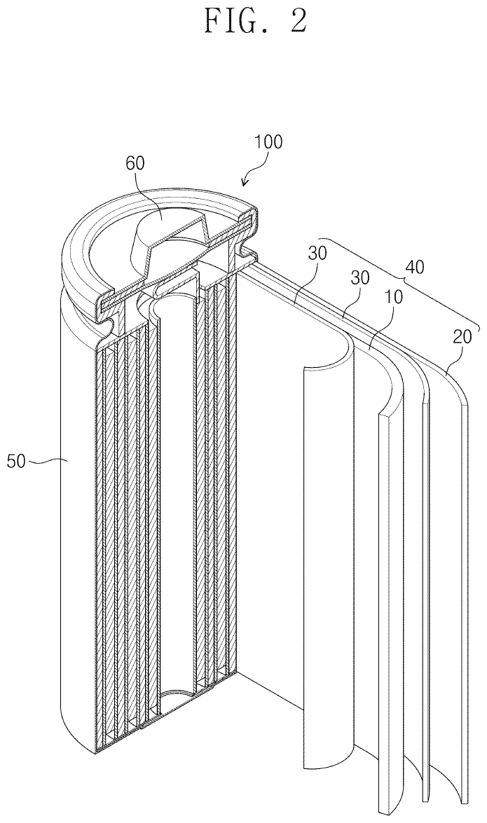

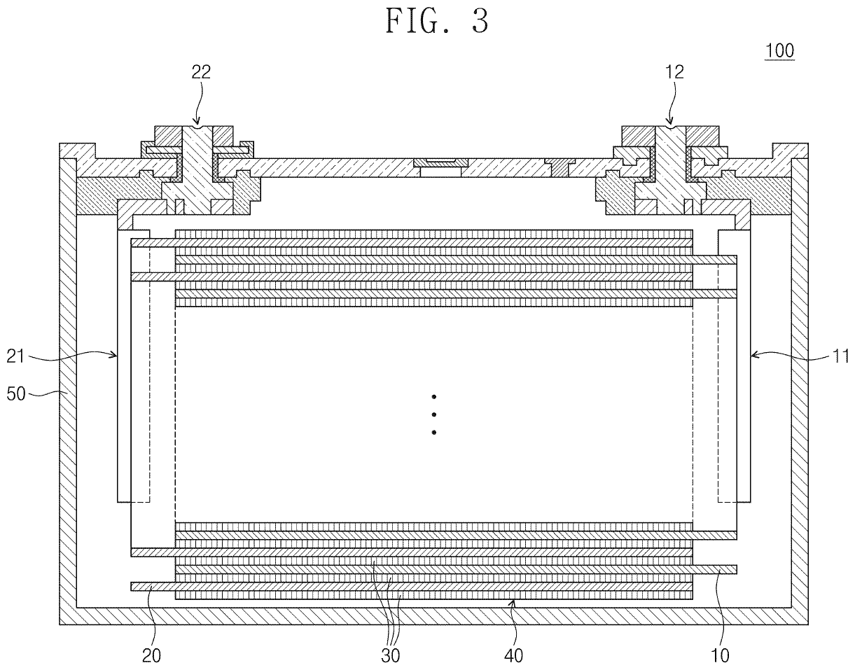

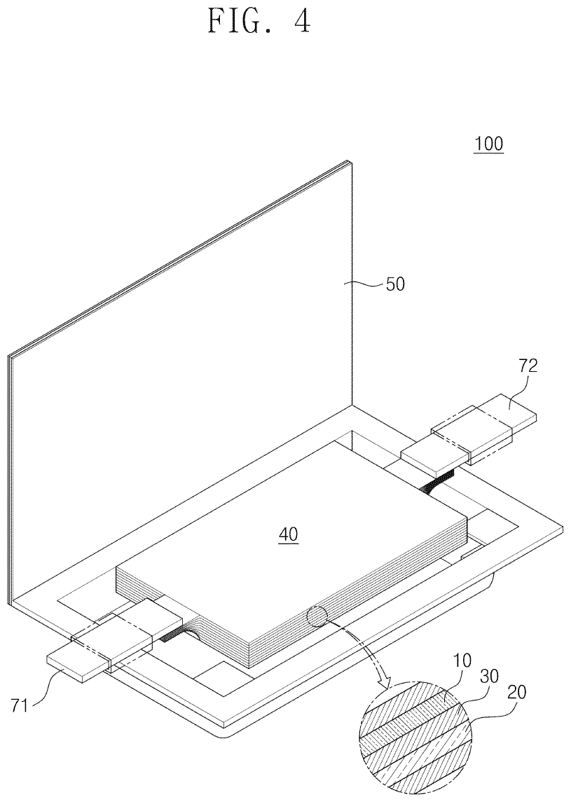

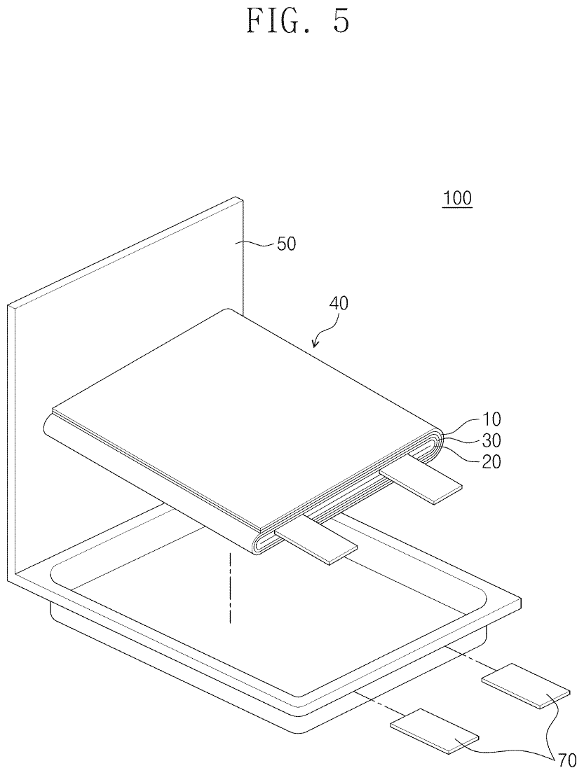

Based on the shape of a rechargeable lithium battery, the rechargeable lithium battery may be classified into cylindrical, prismatic, pouch, and coin types (kinds). FIGS. 2 to 5 illustrate simplified diagrams showing a rechargeable lithium battery according to one or more embodiments. FIG. 2 shows a cylindrical battery, FIG. 3 shows a prismatic battery, and FIGS. 4 and 5 each show a pouch-type or kind battery. Referring to FIGS. 2 to 4, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte. The rechargeable lithium battery 100 may include a sealing member 60 that seals the casing 50 as illustrated in FIG. 2. In one or more embodiments, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4 and 5, the rechargeable lithium battery 100 may include an electrode tab 70, or a positive electrode tab 71 and a negative electrode tab 72, which serves as an electrical path for inducing a current generated in the electrode assembly 40 to the outside.

A rechargeable lithium battery according to one or more embodiments of the present disclosure may be applied to automotive vehicles, mobile phones, and/or any other electrical devices, but the present disclosure is not limited thereto.

Examples and Comparative Examples of the present disclosure will be described in more detail as follows. The following examples are only embodiments of the present disclosure, and the present disclosure is not limited to the following examples.

### EXAMPLES AND COMPARATIVE EXAMPLES

### Synthesis Example

Catechol of 2.2 g and dichloromethane of 20 mL were provided in a 3-neck round bottomed flask that was already flame-dried, and a solution in which triethylamine of 8.07 g was dissolved in dichloromethane of 5 mL under a nitrogen environment was provided to the flask, and then a sulfuryl chloride fluoride gas was added while the mixture was agitated at 23° C. The agitation was continued in a state filled with gas. After the termination of the reaction, dichloromethane of 25 mL was added together with water of 50 mL, and then a produced organic layer was extracted three times. The extracted organic layer was washed twice with water of 25 mL, and then dried by utilizing a magnesium sulfate drying agent. A rotary evaporator was utilized to eliminate a solvent from the dried organic layer, and silica-filtered purified to eventually obtain a compound represented by Chemical Formula 1-1.

1H NMR (400 MHZ, CDCl3) δ7.21 (m, 4H); 13C NMR (100 MHZ, CDCl3) δ142.79, 125.50, 112.00;

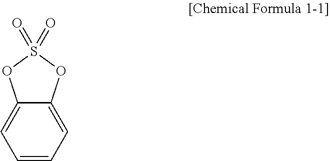 [SMILES: O=S1(=O)Oc2ccccc2O1]

### Example 1

### (1) Preparation of Electrolyte

LiPF₆ of about 1.0 M was dissolved in a non-aqueous organic solvent in which ethylene carbonate (EC), ethylmethyl carbonate (EMC), and dimethyl carbonate (DMC) were mixed in a volume ratio of about 20:40:40, and an additive was added to prepare an electrolyte.

As the additive, Compound 1 represented by Chemical Formula 1-1 was added in an amount of 0.1 wt % relative to the total amount of the electrolyte, and Compound 2 represented by Chemical Formula 2 was added in an amount of 1 wt % relative to the total amount of the electrolyte.

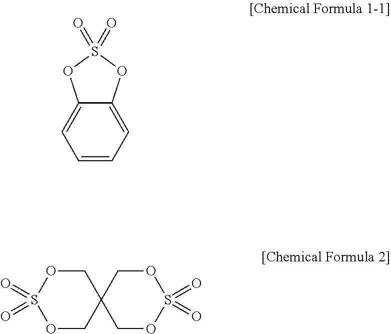 [SMILES: O=S1(=O)Oc2ccccc2O1 ; O=S1(=O)OCC2(CO1)COS(=O)(=O)OC2]

### (2) Fabrication of Rechargeable Lithium Battery

LiNiCoAlO₂ (NCA) as a positive electrode active material, polyvinylidene fluoride as a binder, and acetylene black as a conductive material were mixed in a weight ratio of 96:3:1, and the mixture was distributed (e.g., dispersed) in N-methyl pyrrolidone to prepare a positive electrode active material slurry.

The positive electrode active material slurry was coated on an Al foil of 15 μm in thickness, dried at a temperature of 100° C., and then pressed to manufacture a positive electrode.

A silicon negative electrode active material, a styrene-butadiene rubber binder, and carboxymethyl cellulose were mixed in a weight ratio of 98:1:1, and dispersed (e.g., dispersed) in distilled water to prepare a negative electrode active material slurry.

The negative electrode active material slurry was coated on a copper (Cu) foil with a thickness of 10 μm, dried at 100° C., and then pressed to manufacture a negative electrode.

The positive electrode, the negative electrode, and a 10 μm-thick polyethylene separator were assembled to manufacture an electrode assembly, and the electrolyte was introduced to fabricate a rechargeable lithium battery.

### Example 2

A rechargeable lithium battery was fabricated by substantially the same method as that of Example 1, except that, as an additive, Compound 1 was added in an amount of 0.5 wt % relative to the total amount of the electrolyte, and Compound 2 was added in an amount of 1 wt % relative to the total amount of the electrolyte.

### Example 3

A rechargeable lithium battery was fabricated by substantially the same method as that of Example 1, except that, as an additive, Compound 1 was added in an amount of 1 wt % relative to the total amount of the electrolyte, and Compound 2 was added in an amount of 1 wt % relative to the total amount of the electrolyte.

### Example 4

A rechargeable lithium battery was fabricated by substantially the same method as that of Example 1, except that, as an additive, Compound 1 was added in an amount of 1.5 wt % relative to the total amount of the electrolyte, and Compound 2 was added in an amount of 1 wt % relative to the total amount of the electrolyte.

### Comparative Example 1

A rechargeable lithium battery was fabricated by substantially the same method as that of Example 1, except that, as an additive, vinylene carbonate was added in an amount of 1.5 wt % relative to the total amount of the electrolyte, vinylene ethylene carbonate was added in an amount of 0.5 wt % relative to the total amount of the electrolyte, and neither Compound 1 nor Compound 2 was added.

### Comparative Example 2

A rechargeable lithium battery was fabricated by substantially the same method as that of Example 1, except that, as an additive, Compound 1 was not added, and Compound 2 was added in an amount of 1 wt % relative to the total amount of the electrolyte.

### Comparative Example 3

A rechargeable lithium battery was fabricated by substantially the same method as that of Example 1, except that, as an additive, Compound 1 was not added, and Compound 2 was added in an amount of 1.5 wt % relative to the total amount of the electrolyte.

### Evaluation Example

A rechargeable lithium battery was evaluated by the following method.

### Evaluation 1: Lifetime Characteristics at 45° C. of Lithium Battery

### (1) Capacity Retention Rate

The rechargeable lithium battery according to each of Examples and Comparative Examples was fabricated in the form of a 7 Ah prismatic type or kind, and the battery was charged at 0.33 C-rate to 4.25 V/350 mA under constant current and constant voltage (CC/CV) at 25° C. Afterwards, the battery was charged at 0.33 C-rate to 4.25 V/350 mA, and then a charge/discharge device (e.g., PNE-0506 commercially available from PNE Solution Co. Ltd.) was utilized to measure an initial capacity while the battery was discharged at 0.33 aC-rate under constant current (CC) until a voltage thereof is 2.8 V. In addition, the same battery was charged at 0.33 C-rate to 4.25 V/350 mA under constant current and constant voltage (CC/CV) at 45° C., and then discharged at 0.5 C-rate under constant current (CC) until a voltage thereof is 2.8 V. This procedure was repeated 300 times.

The measured discharge capacity was utilized to calculate a capacity retention rate according to Equation 1 and the results are listed in Table 1.

$$Capacity retention rate ( \% ) = ( discharge capacity after 300 cycles / initial discharge capacity ) \times 100 \qquad [ Equation 1 ]$$

### (2) DCIR Increase Rate

After the rechargeable lithium battery according to each of Examples and Comparative Examples was allowed to measure an initial direct-current internal resistance (DCIR) as ΔV/ΔI (voltage change/current change), a maximum energy state of the battery was changed into a fill charge state (SOC 100%). In this state, the battery was charged at 0.33 C-rate to 4.25 V/350 mA under constant current and constant voltage (CC/CV) at 45° C., and then discharged at 0.5 C-rate under constant current (CC) until a voltage thereof is 2.8 V. After this process was repeated 300 times, a direct-current internal resistance was measured, a DCIR increase rate (%) was calculated according to Equation 2, and the results are listed in Table 1.

$$DCIR increase rate ( \% ) = ( DCIR after 300 cycles / initial DCIR ) \times 100 \qquad [ Equation 2 ]$$

### Evaluation 2: Storage Characteristics at 60° C. of Lithium Battery

### (1) Capacity Retention Rate

The rechargeable lithium battery according to Examples and Comparative Examples was fabricated in the form of a 7 Ah prismatic type or kind, and under constant current and constant voltage (CC/CV) at 25° C., the battery was charged at 0.33 C-rate to 4.25 V/350 mA. Afterwards, a charge/discharge device (e.g., PNE-0506 commercially available from PNE Solution Co. Ltd.) was utilized to measure an initial capacity while the battery was discharged at 0.33 C-rate under constant current (CC) until a voltage thereof is 2.8 V. In addition, the same battery was charged at 0.33 C-rate to 4.25 V/350 mA under constant current and constant voltage (CC/CV) at 25° C., and then stored for 30 days in an oven at 60° C. Thereafter, a discharge capacity after 30 days was measured.

The measured discharge capacity was utilized to calculate a capacity retention rate according to Equation 1, and the results were listed in Table 1.

$$Capacity retention rate ( \% ) = ( discharge capacity after 30 cycles / initial discharge capacity ) \times 100 \qquad [ Equation 3 ]$$

### (2) DCIR Increase Rate

After the rechargeable lithium battery according to Examples and Comparative Examples was allowed to measure an initial direct-current internal resistance (DCIR) as ΔV/ΔI (voltage change/current change), a maximum energy state of the battery was changed into a fill charge state (SOC 100%). In this state, the battery was stored in a high-temperature oven for 30 days at 60° C., a direct-current internal resistance after 30 days was measured, a DCIR increase rate (%) was calculated according to Equation 4, and the results are listed in Table 1.

$$DCIR increase rate ( \% ) = ( DCIR after 30 days / initial DCIR ) \times 100 \qquad [ Equation 4 ]$$

TABLE 1

| | | | Lifetime | | Lifetime | |
|---|---|---|---|---|---|---|
| | | | characteristics at | | characteristics at | |
| | Composition | | 45° C. (300 cycles) | | 60° C. (after 30 days) | |
| | of additive | | Capacity | DCIR | Capacity | DCIR |
| | Compound 1 | Compound 2 | retention | increase | retention | increase |
| Category | (wt %) | (wt %) | rate (%) | rate (%) | rate (%) | rate (%) |
| Example 1 | 0.1 | 1 | 86.1 | 132.7 | 95.2 | 120 |
| Example 2 | 0.5 | 1 | 85.6 | 128.1 | 96 | 123.1 |
| Example 3 | 1 | 1 | 84.8 | 140.2 | 95.5 | 126.4 |
| Example 4 | 1.5 | 1 | 84.5 | 144.6 | 94 | 145.3 |
| Comparative | —* | — | 84.4 | 168.3 | 90.1 | 148.1 |
| Example 1 | | | | | | |
| Comparative | — | — | 83.1 | 151.9 | 93.4 | 152.6 |
| Example 2 | | | | | | |
| Comparative | — | 1.5 | 81.5 | 148.1 | 93.7 | 148.1 |
| Example 3 | | | | | | |

*, —, or —* indicates no addition (not included).

An electrolyte according to one or more embodiments for a rechargeable lithium battery may achieve stabilization of the electrodes and suppression of a resistance increase, and thus there may be an effect of improvement in stability and lifetime characteristics at relatively high temperatures.

The use of “may” when describing embodiments of the inventive concept refers to “one or more embodiments of the inventive concept.”

As used herein, the term “and/or” includes any and all combinations of one or more of the associated listed items. Throughout the disclosure, the expression “at least one of a, b or c”, “at least one selected from a, b, and c”, “at least one selected from the group consisting of a, b, and c”, “at least one from among a, b, and c”, “at least one selected from among a, b, and c”, etc., indicates only a, only b, only c, both (e.g., simultaneously) a and b, both (e.g., simultaneously) a and c, both (e.g., simultaneously) b and c, all of a, b, and c, or variations thereof.

As used herein, the term “about,” and similar terms are used as terms of approximation and not as terms of degree, and are intended to account for the inherent deviations in measured or calculated values that would be recognized by those of ordinary skill in the art. “About” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

A battery management system (BMS) device, and/or any other relevant devices or components according to embodiments of the present invention described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

While this disclosure has been described in connection with what is presently considered to be practical example embodiments, it is to be understood that the present disclosure is not limited to the disclosed embodiments and is intended to cover various suitable modifications and equivalent arrangements included within the spirit and scope of the appended claims, and equivalents therefore. Therefore the aforementioned embodiments should be understood to be examples but not limiting this disclosure in any way.

What is claimed is:

1. An electrolyte comprising:
a non-aqueous organic solvent;
a lithium salt; and
an additive,
wherein the additive comprises Compound 1 represented by Chemical Formula 1 and Compound 2 represented by Chemical Formula 2, 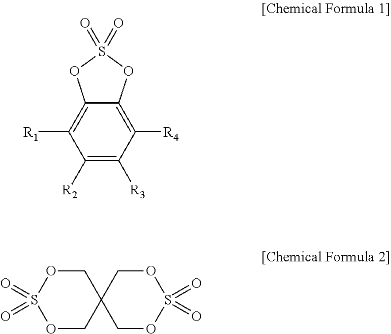
wherein, in Chemical Formula 1, R₁ to R₄ are each independently a hydrogen atom, a halogen atom, or a substituted or unsubstituted C1 to C5 alkyl group, and
wherein the electrolyte is for a rechargeable lithium battery.

2. The electrolyte as claimed in claim 1, wherein the additive is about 0.1 wt % to about 10 wt % in amount based on a total weight of 100 wt % of the electrolyte.

3. The electrolyte as claimed in claim 1, wherein Compound 1 is less in amount than that of Compound 2.

4. The electrolyte as claimed in claim 1, wherein Compound 1 is about 0.01 wt % to about 1 wt % in amount based on a total weight of 100 wt % of the electrolyte.

5. The electrolyte as claimed in claim 1, wherein Compound 2 is about 0.01 wt % to about 2 wt % based on a total weight of 100 wt % of the electrolyte.

6. The electrolyte as claimed in claim 1, wherein Compound 2 is 1 to 20 parts by weight relative to 1 part by weight of the Compound 1.

7. The electrolyte as claimed in claim 1, wherein R₁ to R₄ are each a hydrogen atom.

8. The electrolyte as claimed in claim 1, wherein the non-aqueous organic solvent comprises at least one selected from among ethylene carbonate (EC), propylene carbonate (PC), propyl propionate (PP), ethylmethyl carbonate (EMC), dimethyl carbonate (DMC), diethyl carbonate (DEC), dipropyl carbonate (DPC), methylpropyl carbonate (MPC), ethylpropyl carbonate (EPC), methylethyl carbonate (MEC), and butylene carbonate (BC).

9. The electrolyte as claimed in claim 8, wherein the non-aqueous organic solvent comprises ethylene carbonate (EC), ethylmethyl carbonate (EMC), and dimethyl carbonate (DMC).

10. The electrolyte as claimed in claim 1, wherein the lithium salt comprises at least one selected from among LiPF₆, LiBF₄, LiSbF₆, LiAsF₆, LiClO₄, LiAlO₂, LiAlCl₄, LiPO₂F₂, LiCl, LiI, LiN(SO₃C2F₅)₂, Li(FSO₂)₂N, lithium bis(fluorosulfonyl)imide (LiFSI), and LiC₄F₉SO₃.

11. The electrolyte as claimed in claim 1, wherein a concentration of the lithium salt is in a range of about 0.1 M to about 2.0 M.

12. A rechargeable lithium battery, comprising:
a positive electrode comprising a positive electrode active material;
a negative electrode comprising a negative electrode active material; and
the electrolyte as claimed in claim 1.

13. The rechargeable lithium battery as claimed in claim 12, wherein the positive electrode active material comprises a lithium metal oxide represented by Chemical Formula 3,
LiₐNi_{1-b-c}CO_{b}X_{c}O_{2-α}D_{α} [Chemical Formula 3]
wherein in Chemical Formula 3,
X is Al, Ni, Co, Mn, Cr, Fe, Mg, Sr, V, a rare-earth element, or a combination thereof,
D is O, F, S, P, or a combination thereof,
0.90≤a≤1.8,
0≤b≤0.5,
0≤c≤0.5, and
0<α<2.

14. The rechargeable lithium battery as claimed in claim 12, wherein the negative electrode active material comprises a carbon-based negative electrode active material, a silicon (Si)-based negative electrode active material, a tin (Sn)-based negative electrode active material, or a combination thereof.
